(19) United States
(12) Patent Application Publication
(10) Pub. No.: US 2024/0242524 A1
(43) Pub. Date: Jul. 18, 2024

(54) A SYSTEM AND METHOD FOR SINGLE STAGE DIGIT INFERENCE FROM UNSEGMENTED DISPLAYS IN IMAGES

(71) Applicant: Palo Alto Research Center Incorporated, Palo Alto, CA (US)

(72) Inventors: Robert Roy Price, Palo Alto, CA (US); Yan-Ming Chiou, Milpitas, CA (US); Shanmuka Sai Sumanth Yenneti, Sterling, VA (US)

(73) Assignee: Palo Alto Research Center Incorporated, Palo Alto, CA (US)

(21) Appl. No.: 18/097,906

(22) Filed: Jan. 17, 2023

(51) Int. Cl. G06V 30/18; G06V 10/774; G06V 10/82; G06V 30/30

(52) U.S. Cl. CPC G06V 30/18; G06V 10/774; G06V 10/82; G06V 30/30

(57) ABSTRACT

A system and method for reading digits using VGG-16 backbone are provided to create visual features followed by two layers of non-linear fully connected units which are then fed to 8 categorical symbol units and a single linear length unit. The 8 categorical units provide an ordered representation of the numerical reading with required punctuation such as decimal points or colons. Training on synthetic digits followed by augmentations to create a robust detector are implemented without the need for real-world training data.

### BACKGROUND

There are a variety of applications in the real world where it is useful to be able to read digital displays to automatically populate or verify data for the user. For instance, in a health-care application, a phone-based app might automatically read the display on a glucose meter to record the value for the user. As a further example, in an automatic logging application, the system might verify that the weight of an ingredient has been measured to ensure a repeatable chemical process. These types of applications cannot be addressed by simply finetuning a current network with a small number of examples of digits, because the goal is not to simply recognize a clock or microwave display based on the style of its digits. The goal is to actually read out the digits.

Thus, there is a need for recognizing and parsing texts in the wild, but not much work has been done for single step digit recognizing. Traditional methods first perform image preprocessing such as image binarization, thresholding and remove gaps in characters fonts using erosion techniques. Then, they segment digit candidates followed by the classification of individual digits. An example of this approach uses Mask RCNN to find potential digits boxes, these regions are then classified and then a heuristic is used to try to string digits together.

Other researchers have created methods for mobile devices using deep learning methods. However, these require the user to specify the region from where the digits will be extracted.

Some early work showed that characters could be extracted with simple networks but this required large datasets extracted from, for example, Google Street view and further required hand labeling. Also, there are commercial APIs but these require a network connection and cannot be tuned for specific types of displays and impose a cost on projects that wish to adopt this technology.

Therefore, known approaches require large networks, end-user highlighting of relevant regions, or a network connection to server based implementation. For these reasons, known approaches are deficient.

### BRIEF DESCRIPTION

According to one aspect of the presently described embodiments, a system comprises at least one processor, at least one memory, wherein the at least one memory has stored thereon instructions that, when executed by the at least one processor, cause the system at least to receive an input image having a display of digits included therein, extract features from the input image using a trained feature generating network to identify digits in the display, perform processing using two layers of trained non-linear units, and output up to eight digits and an indicator of a number of digits detected in the display.

According to another aspect of the presently described embodiments, the trained feature generating network is a convolutional network.

According to another aspect of the presently described embodiments, the trained feature generating network is followed by the two layers of trained non-linear units that are fully connected.

According to another aspect of the presently described embodiments, the digits are output as eight independent categorical outputs.

According to another aspect of the presently described embodiments, the indicator of the number of digits detected in the display is output in one linear unit.

According to one aspect of the presently described embodiments, a method comprises receiving an input image having a display of digits included therein, extracting features from the input image using a trained feature generating network to identify digits in the display, performing processing using two layers of trained non-linear units, and outputting up to eight digits and an indicator of a number of digits detected in the display.

According to another aspect of the presently described embodiments, the trained feature generating network is a convolutional network.

According to another aspect of the presently described embodiments, the two layers of trained non-linear units are fully connected.

According to another aspect of the presently described embodiments, the digits are output as eight independent categorical outputs.

According to another aspect of the presently described embodiments, the indicator of the number of digits detected in the display is output in one linear unit.

According to one aspect of the presently described embodiments, a system comprises at least one processor, at least one memory, wherein the at least one memory has stored thereon instructions that, when executed by the at least one processor, cause the system at least to receive images of collected random display styles, augment the images by modifying orientation or substituting backgrounds, and train a detecting system using the augmented images.

According to another aspect of the presently described embodiments, the detecting system is based on a feature generating network.

According to another aspect of the presently described embodiments, the detecting system is based on a convolutional network.

According to another aspect of the presently described embodiments, the detecting system is based on a VGG-16 system or a Resnet system.

According to one aspect of the presently described embodiments, a method comprises receiving images of collected random display styles, augmenting the images by modifying orientation or substituting backgrounds, and training a detecting system using the augmented images.

According to another aspect of the presently described embodiments, the detecting system is based on a feature generating network.

According to another aspect of the presently described embodiments, the detecting system is based on a convolutional network.

According to another aspect of the presently described embodiments, the detecting system is based on a VGG-16 system or a Resnet system.

### BRIEF DESCRIPTION OF THE DRAWINGS

FIG. 1 is a diagram according to the presently described embodiments;

FIG. 2 is a flowchart illustrating an example method according to the presently described embodiments;

FIG. 3 is an illustration showing samples of training data;

FIGS. 4(a)-4(f) are an illustration showing augmentation of data for training purposes;

FIG. 5 is a flowchart illustrating an example method according to the presently described embodiments; and,

FIG. 6 is an example system into which the presently described embodiments are incorporated.

### DETAILED DESCRIPTION

As can be seen from the current state of the art above, it would be advantageous to develop a network that can learn where to look for numbers as well as identify the digits in that number at the same time, without any extra input regarding the position/orientation of these numbers. Also, it would be advantageous to exploit inter-character style characteristics common to all digits in a display to improve recognition. Still further, it would be advantageous to have the ability to generalize to thousands of possible readings and to handle things like decimal points and colons well (to read digital clocks or scales).

According to the presently described embodiments, a robust digit detector is realized without a need for massive quantities of labeled real world data. This is accomplished by training the network on synthetic images and augmenting them. As a result, at least one form of the presently described embodiments simultaneously infers eight digits in a single stage and is able to recognize decimal points and colons.

For example, in assistance applications or interfaces to legacy non-connected devices, the presently described embodiments are helpful to extract readings from digital displays. For instance, a user might want to read a microwave display, read a scale or thermometer or check a glucose monitor and automatically fill in a log. As alluded to above, using conventional techniques on a server, the approach for the user or conventional system would be to perform text spotting, crop and normalize text and then feed it to an OCR engine. In a mobile or embedded device setting contemplated by at least some examples of the presently described embodiments, a compact solution with low latency is desired. In at least one form, the presently described embodiments simultaneously isolate and decode digits in digital displays using a lightweight network capable of running on low-power devices. The approach makes use of display synthesis and augmentation technique to implement sim-to-real style training. This model generalizes to a variety of devices and can read times, weights, temperatures and other types of values on a variety of devices and in a variety of environments including, for example, without limitation, scales, meters, gauges, . . . etc. When coupled with a generic object detector, it provides a powerful computationally efficient solution to recognizing objects and their displays. The variety of devices into which the presently described embodiments could be incorporated include, for example, without limitation, tablets, augmented reality devices, head or chest mounted interactive devices, cameras, webcams, mobile phones or devices, or other devices, systems or networks that can be used to assist in accomplishing tasks, either in-person or remotely (in the case of, for example, a webcam).

Thus, the presently described embodiments, in at least one form, are intended to read device displays, e.g., extract readings from digital displays in unsegmented images, to support assistance applications, monitoring and digitalization of legacy measuring devices, for instance, thermometer readings, clock readings, digital current measurement and others.

In at least one form, a light-weight single stage method is provided that directly outputs digits and other markers such as decimal points and colons without the need for a user to indicate the display region and without a multi-step pipeline that first segments out digits and then reassembles them. That is, a robust light-weight network is provided to extract and read out 7 segment displays that executes in a single pass without needing to call out to an OCR service without a need for a huge, labeled dataset. This provides selected advantages over conventional approaches, some noted above, that require the user to highlight the display region or use a heavyweight digit detection stage (Mask RCNN) followed by digit identification and then heuristic assembly of digits into strings.

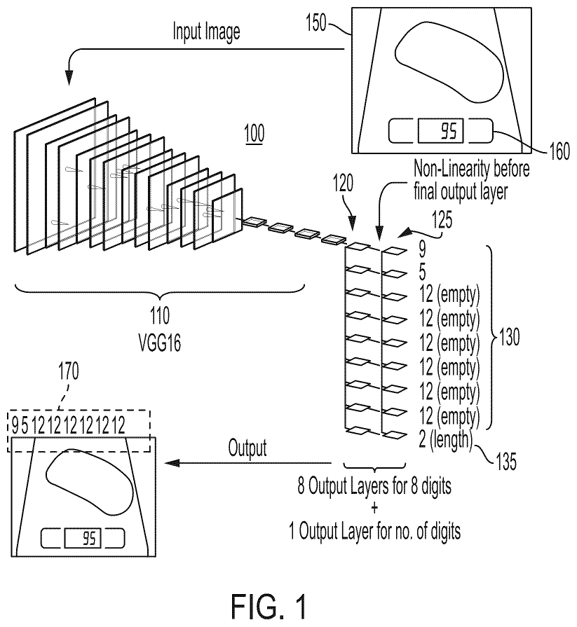

With reference to FIG. 1, a system 100 makes use of a single stage deep network. The system 100 receives an input, e.g., an input image 150 having included therein a display, e.g., a display 160, processes the image, as will be described, and generates an output 170 of digits—effectively reading the display 160 in the input image 150. The system, 100, in at least one form, includes a trained feature generating network such as a convolutional network. As shown, a 16-layer VGG 16 convolutional network 110 is used as a backbone for feature extraction although other backbones such as Resnet or other feature generating networks are possible. This is followed by 2 layers 120, 125 of non-linear fully connected units and finally eight independent categorical outputs 130 representing up to eight possible digits in sequence. More or less digits (e.g., 5 or 10 digits) are easily imagined. Each categorical output can represent a digit (0-9), a blank, a decimal, or a colon. One additional linear unit 135 predicts the length of the number. This additional unit helps to improve the accuracy of the digit reasoning by getting the length of the number correct which may filter out false digits inspired by noise (labels on the device next to the display). In at least one form, a sixteen layer VGG-16 system is used and modified to remove its last layer and feed into the two output layers, as described. Further, it is to be appreciated that, in at least one form, the system is trained at least at the significant stages of the backbone, the non-linear units, and the categorical output.

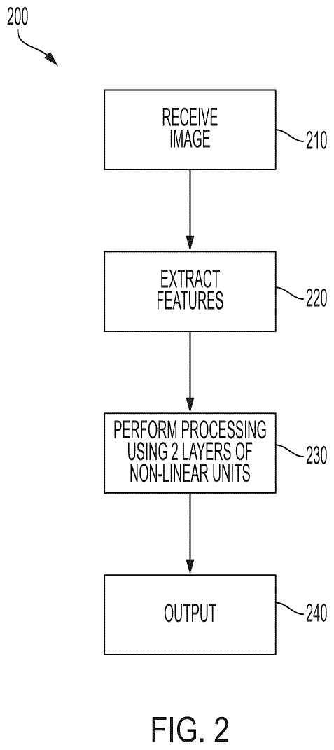

Referring now to FIG. 2, an example method according to the presently described embodiments is illustrated. As shown, a method 200 reflects the system flow diagram of FIG. 1. As shown, the method 200 is initiated upon receiving an input image (at 210), such as input image 150 of FIG. 1. Of course, the method may be implemented or triggered using any appropriate technique. For example, a user may trigger the method using a button (hard or soft) on an appropriate device and capturing or viewing an image including a display that requires reading of the display. Or the method can be triggered by a regular clock pulse to provide continuous automatic updates. Next, the image is processed by, first, undergoing feature extraction (at 220). It should be understood that feature extraction may be performed in a variety of manners; however, in at least one form, a 16-layer VGG 16 convolutional network (or other feature generating network, including but not limited to a Resnet system) is used as a backbone. The image is further processed by performing suitable processing (at 230) by two (2) layers of non-linear fully connected units. Again, a variety of suitable approaches may be used for this processing. Once all processing is complete, up to eight (8) digits plus an indicator of a number of output digits are output (at 240) depending on how many digits are detected on the display to be read. The maximum number of digits that can be read is a parameter that can be set for specific applications (e.g., 5 digits for a time with a colon, etc.). It will be appreciated that, when a digit is not detached, a placeholder will be output, in at least some form. For example, referring back to FIG. 1, the digits “9” and “5” are output along with an indication, i.e., “2”, of the number of digits detected. The other possible digits, which in the FIG. 1 example do not exist, correspond to an output of “12” as a placeholder or indicator of no digit detected.

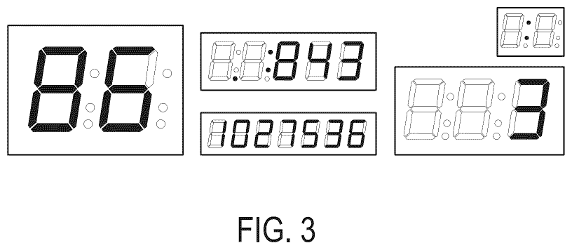

With reference to FIG. 3, the machine learning based approach according to the presently described embodiments (including use of feature generating networks as described, for example) is trained on data generated reflecting a variety of examples of displays with different values, font colors and background styles. FIG. 3 illustrates five (5) random display styles that would, for example, be used to train.

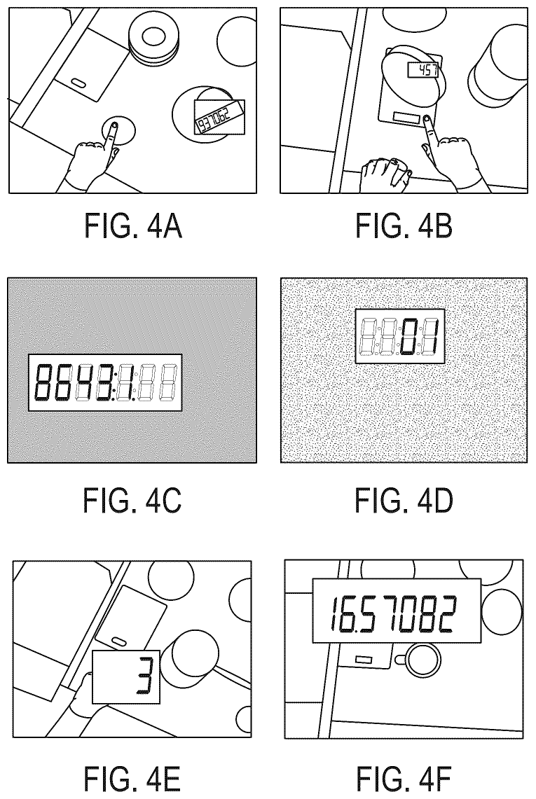

With reference to FIG. 4, the example random displays, which could comprise those of FIG. 3 or others, are then augmented by rotation and scaling and embedding in a variety of backgrounds to increase robustness of inference. In total, in just one example, 60,000 images were generated out of which 55,000 were used for training, 2500 for testing and 2500 for validation.

Although a variety of training approaches may be used, in one example, a network or device was trained for 300 epochs using a loss function consisting of a weighted average of cross-entropy loss per digit and mean squared error of predicted length vs. actual length. The length term in the loss encourages the network to get the correct number of digits and ignore non-numerical characters such as the ‘g’ for grams that appears in the scale display. The loss function may take a variety of forms. However, in at least one form, the loss for this model is a sum of 8 CrossEntropy losses from each of the 8 layers that predict 8 digits and MSELoss from the length prediction.

$$Loss ( c , y ) = \{ \begin{matrix}{\sum }_{i = 1}^{D} {( {x}_{i} - {y}_{i} )}^{2} \\ + \\ - {\sum }_{d = 1}^{D} {\sum }_{c = 1}^{M} {y}_{o , c} log ( {p}_{o , c} )\end{matrix}$$

D: Number of predicted digits
M: Number of possibilities for each digit
y: Predicted Length
X: Actual Length

At runtime, a small amount of deterministic cleanup is done to remove obviously incorrect inferences such as a trailing/leading colon or decimal. On a held out test data set, the model gets 99.4% of digits correct and gets the number of digits correct 98% of the time. The network got 100% correct on a training set and length 98% correct suggesting the network was converging. The closeness of training and test set error suggests that overfitting is not a huge problem. An early experiment on a small but challenging, real-world, hand labeled data set, 92% of digits were recognized and lengths were correct 88.3% of time.

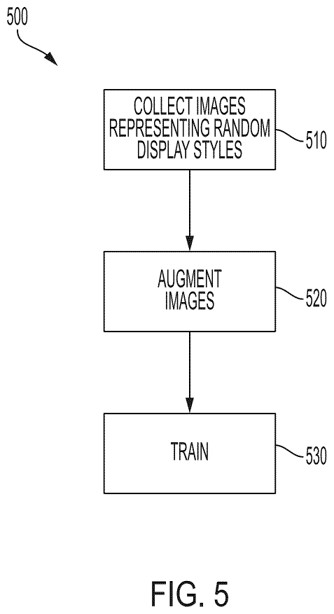

Referring now to FIG. 5, an example method according to the presently described embodiments is illustrated. As shown, in at least one form, the method 500 is a training method. As shown, the method 500 includes collecting images (at 510) representing random display styles for displays that may be detected by the presently described embodiments. These images are then augmented using any of a variety of techniques (at 520). In this regard, the augmentation could include rotating the images (as in FIG. 4(a)) or other orientation changing or scaling functions. The augmentation could include substituting or embedding different backgrounds for the random displays (as in FIG. 4(b)-4(f)). Further, the augmentation may include modifying the images by reproducing them in low resolution—which could also be accomplished by adding or originally selecting random images having low resolution. Once the data set is selected and augmented, the system is trained using the data set (at 530). According to the presently described embodiments, the system trained, in at least one form, is based on a feature generating network such as a convolutional network. As noted, the convolutional network may take a variety of forms, including a VGG-16 system or a Resnet system.

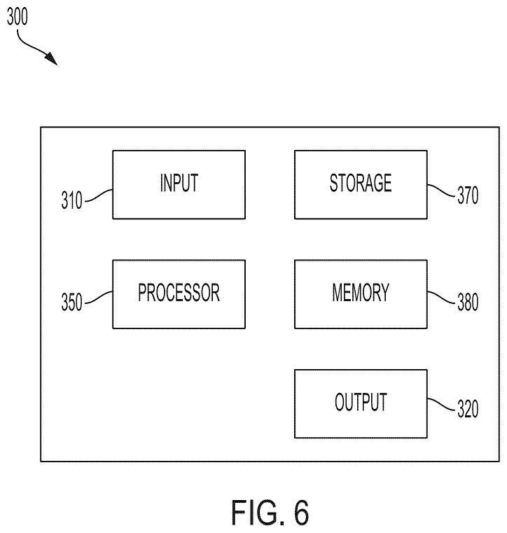

With reference now to FIG. 6, the above-described methods 200 and 500 and other methods according to the presently described embodiments, as well as suitable architecture such as system components useful to implement the system 100 shown in FIG. 1 and in connection with other embodiments described herein can be implemented on a computer using well-known computer processors, memory units, storage devices, computer software, and other components. A high-level block diagram of such a computer is illustrated in FIG. 6. Computer 300 contains at least one processor 350, which controls the overall operation of the computer 300 by executing computer program instructions which define such operation. The computer program instructions may be stored in at least one storage device or memory 380 (e.g., a magnetic disk or any other suitable non-transitory computer readable medium or memory device) and loaded into another memory 380 (e.g., a magnetic disk or any other suitable non-transitory computer readable medium or memory device), or another segment of memory 370, when execution of the computer program instructions is desired. Thus, the steps of the methods described herein (such as methods 200 and 500 of FIGS. 2 and 5) may be defined by the computer program instructions stored in the memory 380 and controlled by the processor 350 executing the computer program instructions. The computer 300 may include one or more input elements 310 and output elements 320 for communicating with other devices via a network. The computer 300 also includes a user interface that enables user interaction with the computer 300. The user interface may include I/O devices (e.g., keyboard, mouse, speakers, buttons, etc.) to allow the user to interact with the computer. Such input/output devices may be used in conjunction with a set of computer programs as an annotation tool to annotate images in accordance with embodiments described herein. The user interface also includes a display for displaying images and spatial realism maps to the user.

According to various embodiments, FIG. 6 is a high-level representation of possible components of a computer for illustrative purposes and the computer may contain other components. Also, the computer 300 is illustrated as a single device or system. However, the computer 300 may be implemented as more than one device or system and, in some forms, may be a distributed system with components or functions suitably distributed in, for example, a network or in various locations.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to facilitate embodiments described above.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A system comprising:
at least one processor;
at least one memory, wherein the at least one memory has stored thereon instructions that, when executed by the at least one processor, cause the system at least to:
receive an input image having a display of digits included therein;
extract features from the input image using a trained feature generating network to identify digits in the display;
perform processing using two layers of trained non-linear units; and
output up to eight digits and an indicator of a number of digits detected in the display.

2. The system as set forth in claim 1, wherein the feature generating network is a convolutional network.

3. The system as set forth in claim 1, wherein the feature generating network is followed by the two layers of trained non-linear units that are fully connected.

4. The system as set forth in claim 1, wherein the digits are output as eight independent and trained categorical outputs.

5. The system as set forth in claim 1, wherein the indicator of the number of digits detected in the display is output in one linear unit.

6. A method comprising:
receiving an input image having a display of digits included therein;
extracting features from the input image using a trained feature generating network to identify digits in the display;
performing processing using two layers of trained non-linear units; and
outputting up to eight digits and an indicator of a number of digits detected in the display.

7. The method as set forth in claim 6, wherein the feature generating network is a convolutional network.

8. The method as set forth in claim 6, wherein the two layers of trained non-linear units are fully connected.

9. The method as set forth in claim 6, wherein the digits are output as eight independent and trained categorical outputs.

10. The method as set forth in claim 6, wherein the indicator of the number of digits detected in the display is output in one linear unit.

11. A system comprising:
at least one processor;
at least one memory, wherein the at least one memory has stored thereon instructions that, when executed by the at least one processor, cause the system at least to:
receive images of collected random display styles;
augment the images by modifying orientation or substituting backgrounds; and
train a detecting system using the augmented images.

12. The system as set forth in claim 11, wherein the detecting system is based on a feature generating network.

13. The system as set forth in claim 11, wherein the detecting system is based on a convolutional network.

14. The system as set forth in claim 11, wherein the detecting system is based on a VGG-16 system or a Resnet system.

15. A method comprising:
receiving images of collected random display styles;
augmenting the images by modifying orientation or substituting backgrounds; and
training a detecting system using the augmented images.

16. The method as set forth in claim 15, wherein the detecting system is based on a feature generating system.

17. The method as set forth in claim 15, wherein the detecting system is based on a convolutional network.

18. The method as set forth in claim 15, wherein the detecting system is based on a VGG-16 system or a Resnet system.
